(19) United States
(12) Patent Application Publication
(10) Pub. No.: US 2024/0334512 A1
(43) Pub. Date: Oct. 3, 2024

(54) ALLEVIATE SPECTRAL REGROWTH AND RECEIVE BLOCKING FROM CO-LOCATED RADIOS

(71) Applicant: Cisco Technology, Inc., San Jose, CA (US)

(72) Inventors: Sivadeep Reddy KALAVAKURU, Akron, OH (US); Fred Jay ANDERSON, Lakeville, OH (US); Robert BADEA, Broadview Heights, OH (US); Ardalan ALIZADEH, Milpitas, CA (US)

(73) Assignee: Cisco Technology, Inc., San Jose, CA (US)

(21) Appl. No.: 18/193,368

(22) Filed: Mar. 30, 2023

(51) Int. Cl. H04W 76/15; H04L 1/00; H04W 72/0453

(52) U.S. Cl. CPC H04W 76/15; H04L 1/0013; H04W 72/0453

(57) ABSTRACT

Alleviating spectral regrowth and Receive (RX) blocking may be provided. To alleviate spectral regrowth and RX blocking one or more targeted intermodulation products may be identified for a Transmit (TX) data packet of a radio of a Multi-Link Device (MLD). A puncture resolution and a puncture position on the Bandwidth (BW) of the TX data packet may then be determined. A puncture of the TX data packet may then be caused, wherein the puncture has the puncture resolution and the puncture position.

### TECHNICAL FIELD

The present disclosure relates generally to alleviating spectral regrowth and Receive (RX) blocking from co-located radios.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for alleviating spectral regrowth and Receive (RX) blocking;

FIG. 2 is a graph of an example Power Amplifier (PA) input and a Transmit (TX) chain output;

FIG. 3 is a graph of example TX chain outputs with different punctures;

FIG. 4 is a graph of example TX chain outputs with punctures in different positions;

FIG. 5 is a graph of example TX chain outputs with a power reduction for a 20 MHz resolution;

FIG. 6 is a graph of example TX chain outputs with a power reduction for a 40 MHz resolution;

FIG. 7 is a graph of example TX chain outputs with a power reduction for an 80 MHz resolution;

FIG. 8 is a flow chart of a method for alleviating spectral regrowth and/or Receive (RX) blocking by removing targeted intermodulation products;

FIG. 9 is a flow chart of a method for alleviating spectral regrowth and/or RX blocking by reducing TX power; and

FIG. 10 is a block diagram of a computing device.

### DETAILED DESCRIPTION

### Overview

Alleviating spectral regrowth and Receive (RX) blocking may be provided. To alleviate spectral regrowth and RX blocking one or more targeted intermodulation products may be identified for a Transmit (TX) data packet of a radio of a Multi-Link Device (MLD). A puncture resolution and a puncture position on the Bandwidth (BW) of the TX data packet may then be determined. A puncture of the TX data packet may then be caused, wherein the puncture has the puncture resolution and the puncture position.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The Institute of Electrical and Electronics Engineers (IEEE) 802.11be standard includes a discussion of Multi-Link Devices (MLDs), in which clients and Access Points (APs) can utilize two or more wireless links for traffic (e.g., sending Transmit (TX) signals and receiving Receive (RX) signals) to simultaneously send and/or receive data across different frequency bands and/or channels. In particular, multi-radio Non-Simultaneous Transmission and Reception (NSTR) MLDs, such as an AP, can have multiple wireless links in the same and/or different bands (e.g., a 2.4 GHz band, a 5 Ghz band, a 6 GHz band) to obtain high spectrum efficiency, low delays, and low power consumption.

In multi-radio architectures, two radios may be operating within a same band or different bands with low channel separation. One radio may be acting as an aggressor (e.g., the radio may be sending a TX) while the other radio is a victim. Coexistence issues may amplify when the aggressor is transmitting at a high Bandwidth (BW) (e.g., 160 MHz, 320 Mhz) at edges of Unlicensed National Information Infrastructure (UNII) bands, because spectral regrowth may occur due to Power Amplifier (PA) non-linearity, and the spectral regrowth may leak into the victim receiver. The aggressor radio may cause Signal to Noise Ratio (SNR) compression due to the aggressor radio's Out Of Band (OOB) noise (e.g., spectral regrowth). The spectral regrowth may also lead to RX-sensitivity impacts and/or Error Vector Magnitude (EVM) degradation. If an aggressor signal is strong enough, then the RX Low Noise Amplifier (LNA) of the victim radio may go into compression due to the out of channel broad band power of the aggressor radio.

Spectral regrowth may increase in severity as TX power is increased. Radio Frequency (RF) front-ends may use sharp skirt Dielectric Resonator (DR) filters or Bulk Acoustic Wave (BAW) filters to reject OOB signals. However, filters may not be able to filter out unwanted signals (e.g., OOB signals) if the channel separation between the aggressor radio and the victim radio is less than 250 MHz (e.g., a Transition Band). The filters may not be able to filter out unwanted signals especially in higher BW cases (e.g., the aggressor is on the UNII-5 band edge with the victim at the start of the UNII-3 band, or vice versa). Filters may also not filter out aggressor signals during lower transition BW, with a 50-120 MHz transition for example. Moreover, installing filters to alleviate spectral regrowth may be cost prohibitive. Therefore, systems and methods for alleviating spectral regrowth and RX blocking from co-located radios are described herein.

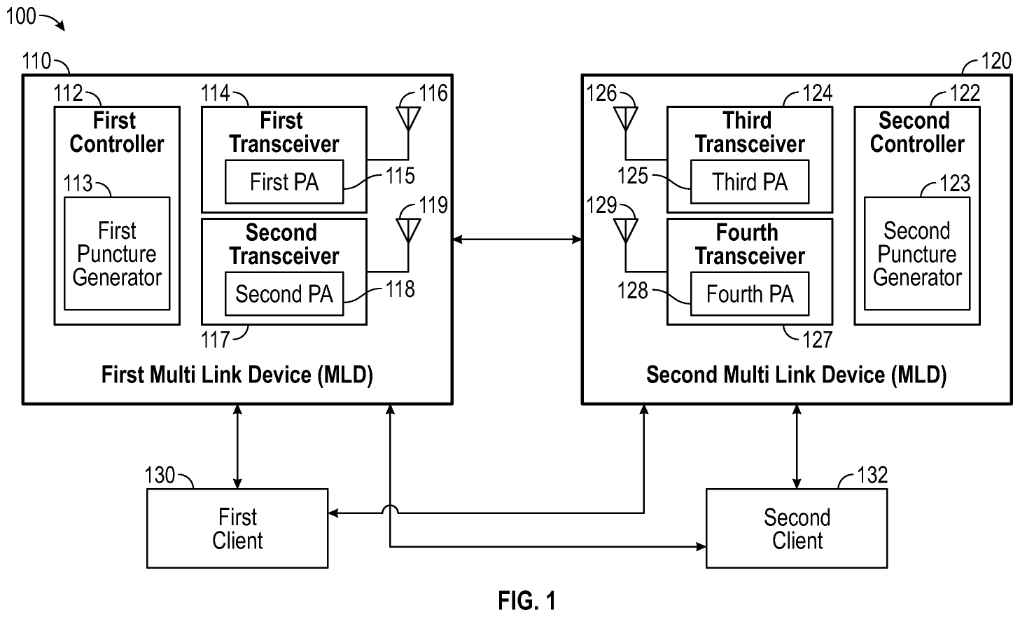

FIG. 1 is a block diagram of an operating environment 100 for alleviating spectral regrowth and Receive (RX) blocking. The operating environment 100 may include a first Multi-Link Device (MLD) 110, a second MLD 120, a first client 130, and a second client 132. The first MLD 110 may include a first controller 112, a first transceiver 114, and a second transceiver 117. The second MLD 120 may include a second controller 122, a third transceiver 124, and a fourth transceiver 127. The first transceiver 114 may include a first Power Amplifier (PA) 115 and be connected to a first antenna 116. The second transceiver 117 may include a second PA 118 and be connected to a second antenna 119. The third transceiver 124 may include a third PA 125 and be connected to a third antenna 126. The fourth transceiver 127 may include a fourth PA 128 and be connected to a fourth antenna 129. The first MLD 110 and/or the second MLD 120 may include more or fewer transceivers in other examples.

The first transceiver 114, the second transceiver 117, the third transceiver 124, and the fourth transceiver 127 may be radio transmitters and receivers which may operate on a band (e.g., UNII frequency bands, 2.4 GHz, 5 GHZ, 6 GHZ). The first transceiver 114 may send TXs and receive RXs using the first antenna 116. For example, the first transceiver 114 may send TXs and/or receive RXs to and/or from the first client 130, the second MLD 120, and/or other systems. The first transceiver 114 may feed a data packet for a TX into the first PA 115 before transmission to amplify the TX signal. The first PA 115 may be non-linear, and the first PA 115 may produce spectral regrowth in the TX because the first PA 115 is non-linear.

Similarly, the second transceiver 117 may use the second antenna 119 and the second PA 118, the third transceiver 124 may use the third antenna 126 and the third PA 125, and the fourth transceiver 127 may use the fourth antenna 129 and the fourth PA 128 to send TXs and receive RXs. The second PA 118, the third PA 125, and the fourth PA 128 may also introduce spectral regrowth because of non-linearity. Because the first MLD 110 and the second MLD 120 have multiple transceivers, the first MLD 110 and the second MLD 120 may utilize multiple network links for traffic across different frequency bands and/or channels. For example, the first MLD 110 may have two links to the second MLD 120, such as a first list between the first transceiver 114 and the third transceiver 124 and a second link between the second transceiver 117 and the fourth transceiver 127. The links may be in a Simultaneous Transmission and Reception (STR) mode and/or an NSTR mode.

The first controller 112 may include a first puncture generator 113, and the second controller 122 may include a second puncture generator 123. The first controller 112 may control the operation of the first transceiver 114 and the second transceiver 117 (e.g., controlling the TX and/or RX of the transceivers). The second controller 122 may control the operation of the third transceiver 124 and the fourth transceiver 127. In an example, the first controller 112 and the second controller 122 use the Media Access Control (MAC) protocol. In other examples, the first puncture generator 113 and/or the second puncture generator 123 may be separate from the first MLD 110 and/or the second MLD 120. The first puncture generator 113 may also be separate from the first controller 112 and/or the second puncture generator 123 may also be separate from the second controller 122.

Spectral regrowth may be received and/or RX blocking may occur if a transceiver of the first MLD 110 (i.e., the first transceiver 114 and/or the second transceiver 117) operates in the same band and/or operates different bands that have low channel separation (e.g., less than 250 MHz separation) compared to the band(s) a transceiver of the second MLD 120 (e.g., the third transceiver 124 and/or the fourth transceiver 127). For example, the first transceiver 114 may be transmitting on the same band the third transceiver 124 is operating on with a link to the first client 130. Thus, the first transceiver 114 may be an aggressor and the third transceiver 124 may be a victim. The third transceiver 124 may experience spectral regrowth and/or RX blocking because of the first transceiver 114 TX. Similarly, the first transceiver 114 may be a victim if the third transceiver 124 sends a TX on the band the first transceiver 114 and the third transceiver 124 are operating on.

In some examples, the transceivers of an MLD (e.g., the first transceiver 114 and the second transceiver 117 of the first MLD 110) may act as aggressors and victims to one another if the transceivers are operating on the same band or on different bands with low channel separation. For example, the first transceiver 114 and the second transceiver 117 may be operating on the same band or different bands with low channel separation. If the first transceiver 114 and/or the second transceiver 117 send a TX, the first transceiver 114 and/or the second transceiver 117 may therefore act as an aggressor to the other transceiver, leading to received spectral regrowth and RX blocking. Therefore, radios (e.g., transceivers) may act as aggressor and/or victims to other radios on a single device (e.g., the first MLD 110, the second MLD 120) and/or to other radios on other devices. A victim transceiver may experience spectral regrowth and/or RX blocking. The spectral regrowth may lead to or otherwise cause SNR compression, RX-sensitivity impacts, Error Vector Magnitude (EVM) degradation, and/or, if an aggressor signal is strong enough, the RX LNA of the victim radio may go into compression.

In another example, the first MLD 110 may have two links to the second MLD 120, such as a first list between the first transceiver 114 and the third transceiver 124 and a second link between the second transceiver 117 and the fourth transceiver 127, with the first link in a first band and the second link in a second band. The first band and the second band may be the same band or different bands that have low channel separation. Thus, for example, if the first transceiver 114 sends a TX, the first transceiver 114 may act as an aggressor transceiver to the second transceiver 117 and/or the fourth transceiver 127, the victim transceiver, because of the TX on the first band leaking and the victim transceiver receiving leakage from the TX on the second link.

As described above, the first MLD 110 and the second MLD 120 may have multiple links operating in STR and/or NSTR modes. Radio Frequency (RF) energy may leak from one TX aspect of a first link to a RX aspect of a second link. The RF energy leakage may cause degraded performance because the RF energy leakage may lower the Signal to Interference and Noise Ratio (SINR) compared to the SINR without the leakage and/or corrupt Channel State Information (CSI). Thus, the transceivers of the first MLD 110 and/or the second MLD 120 may receive spectral regrowth and/or perform RX blocking because of the operations of one or more of the other transceivers, whether it is a transceiver of the same MLD or a different MLD.

Spectral regrowth and/or RX blocking may be alleviated using multiple methods. One method includes identifying intermodulation products removal, and removing the targeted intermodulation products, reducing spectral regrowth and RX blocking. Reducing the spectral regrowth and RX blocking results in the mitigation of OOB leakage. Another method includes adaptively assigning clients to radios and reducing TX power. The adaptive assignment of clients may include assigning clients to radios that can communicate using the reduced power TXs. A third method includes reducing in-band and/or broad band RF energy by removing intermodulation products and/or by reducing TX power. The methods may be used alone and/or in any combination to alleviate spectral regrowth and/or RX blocking. The methods will be described in more detail herein.

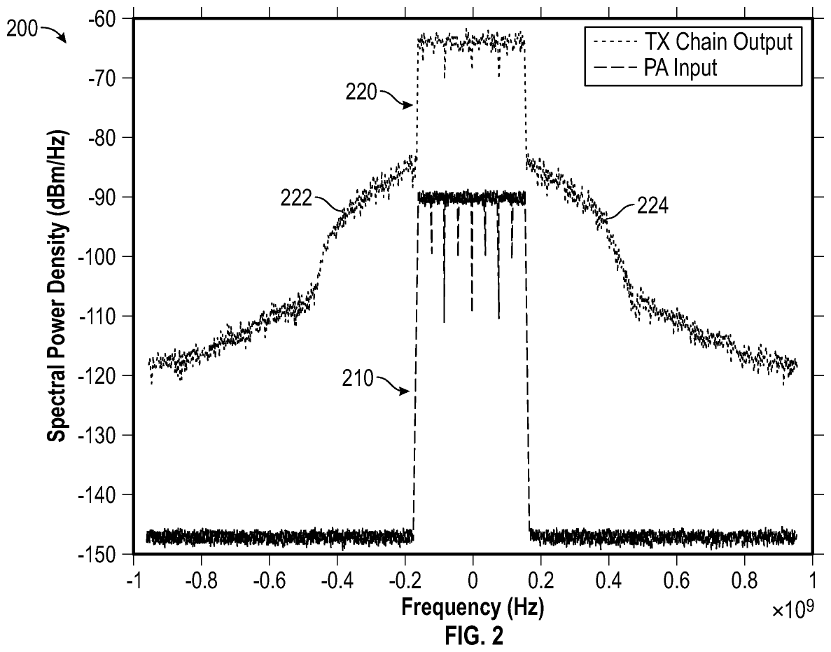

FIG. 2 is a graph 200 of an example PA input 210 and a Transmit (TX) chain output 220. The PA input 210 may be a packet fed through a PA (e.g., the first PA 115, the second PA 118, the third PA 125, and the fourth PA). The TX chain output 220 may be the output of the PA that receives the PA input 210. The TX chain output 220 includes left side spectral regrowth 222 and right side spectral regrowth 224.

A data packet (e.g., a data packet defined by the IEEE 802.11 standard, a Physical Layer Protocol Data Unit), such as the data packet for the PA input 210, can be decomposed into a combination of subcarriers. The combinations of subcarriers may increase with higher BW packets (e.g., up to 4096 subcarriers for a 320 MHz BW). PAS (e.g., the first PA 115, the second PA 118, the third PA 125, and the fourth PA) may introduce nonlinear transformations on the harmonic components of the incident packets. The nonlinear transformations introduced may result in a mixing of the harmonic subcarriers, which can be expressed as a power expansion of the fundamental harmonic subcarriers. These nonlinear transformations may result in the left side spectral regrowth 222 and the right side spectral regrowth 224.

The nonlinear transformations, and particularly the third order products of the nonlinear transformations, may generate intermodulation products (e.g., harmonics) both directly adjacent and within the channel bandwidth at frequencies of, for any two subcarriers numerated i and j, (1) second harmonic frequency j plus or minus first harmonic frequency i (2fⱼ∓fᵢ) and (2) second harmonic frequency i plus or minus first harmonic frequency j (2fᵢ∓fᵢ). Edge channel intermodulation products may be second harmonic frequency i minus first harmonic frequency j (2*fᵢ−fⱼ). The nonlinear transformations may result in a combinatorial problem of fundamental harmonic subcarriers, where each i'th subcarrier combines with each j'th subcarrier comprising the packet and forms numerous combinations of undesired harmonics (e.g., spectral regrowth). There may be many individual subcarrier combinations which contribute to the generation of an individual intermodulation product.

Although each fundamental harmonic subcarrier may contribute to the intermodulation products on either end of a channel the subcarriers at the second frequency of the singularly contribute only to one end of the channel (e.g., the left side spectral regrowth 222 or the right side spectral regrowth 224). Thus, the components below the center frequency contribute at the frequency to the intermodulation products below the channel edge, and components above the center frequency contribute at two time frequency to the intermodulation products above the channel edge. One side or both sides of the spectrum (e.g., 160 MHZ, 320 MHZ) a radio is operating on may have RF leakage (e.g., the left side spectral regrowth 222 and the right side spectral regrowth 224) that may leak into neighbor channels or bands. If the first transceiver 114 and/or the second transceiver 117 is sending a TX, the first controller 112 may identify the intermodulation products that are responsible for spectral regrowth (e.g., the left side spectral regrowth 222 and the right side spectral regrowth 224). The first controller 112 may identify the intermodulation products responsible for spectral regrowth by determining the intermodulation products that are at the edge of the channel or spectrum (e.g., the intermodulation products that are second harmonic frequency i minus first harmonic frequency j (2*fᵢ−fⱼ)). If the third transceiver 124 and/or the fourth transceiver 127 is sending a TX, the second controller 122 may identify the intermodulation products that are responsible for spectral regrowth. In other examples, another system of the MLDs or an external system may identify the intermodulation products to remove to alleviate spectral regrowth and/or RX blocking (e.g., a Wireless Local Area Network (WLAN) controller).

Once the intermodulation products responsible for spectral regrowth, or targeted intermodulation products, are identified, the first controller 112 and/or the second controller 122 may remove the targeted intermodulation products. The first controller 112 may cause the first puncture generator 113 and/or the second controller 122 may cause the second puncture generator 123 to remove the targeted intermodulation products by generating a puncture to puncture the data packet (e.g., the data packet for the PA input 210). The puncture may be at different resolutions (e.g., 20 MHz, 40 MHz, 80 MHZ) based on the targeted intermodulation products to be removed. For example, the first controller 112 and/or the second controller 122 may determine the resolution of the puncture based on the effectiveness of the puncture for reducing spectral regrowth while avoiding losing data of the data packet.

The first controller 112 and/or the second controller 122 may cause the data packet to be punctured in at least two ways. The first method for puncturing the data packet includes normalizing the power of the data packet with the puncture (e.g., increasing Power Spectral Density (PSD) to compensate for the loss of BW caused by the puncture). The second method for puncturing the data packet does not include normalizing the power of the data packet with the puncture. Additionally, when the lower edge of the data packet (e.g., the lower frequency side) is punctured, the first controller 112 and/or the second controller 122 may puncture the data packet with a TX mask (e.g., a TX mask defined by the IEEE 802.11be standard).

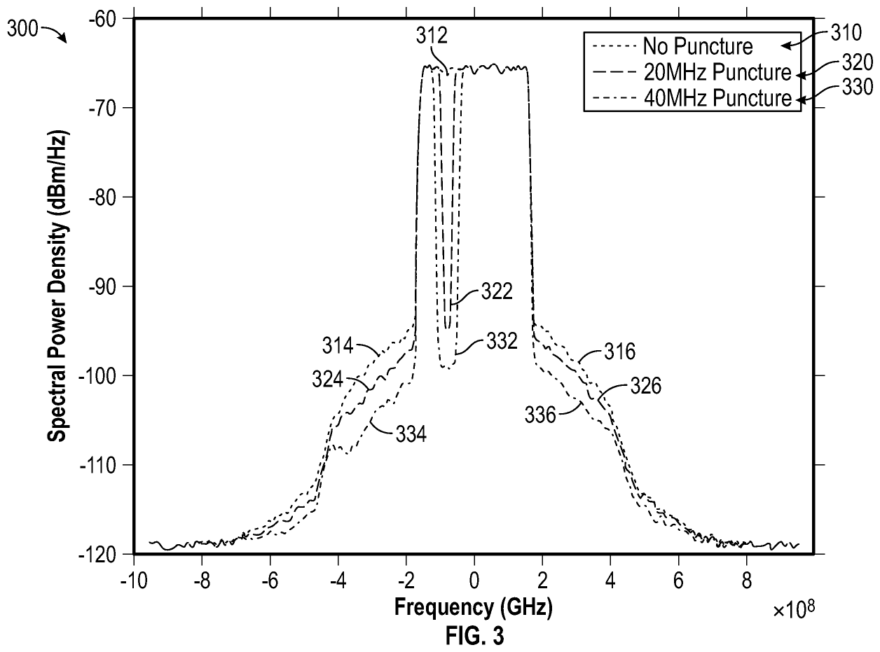

FIG. 3 is a graph 300 of example TX chain outputs with different punctures. The graph 300 includes a first TX chain output 310, a second TX chain output 320, and a third TX chain output 330. The first TX chain output 310 includes no puncture 312, left side spectral regrowth with no puncture 314, and right side spectral regrowth with no puncture 316. The second TX chain output 320 includes a first puncture 322, left side spectral regrowth with the first puncture 324, and right side spectral regrowth with the first puncture 326. The third TX chain output 330 includes a second puncture 332, left side spectral regrowth with the second puncture 334, and right side spectral regrowth with the second puncture 336. The first puncture 322 may be a 20 MHz puncture, and the second puncture 332 may be a 40 MHz puncture.

As illustrated by the graph 300, the left side spectral regrowth with the first puncture 324, right side spectral regrowth with the first puncture 326, left side spectral regrowth with the second puncture 334, and the right side spectral regrowth with the second puncture 336 have lower levels of spectral regrowth compared to the left side spectral regrowth with no puncture 314, and right side spectral regrowth with no puncture 316. Thus, the first puncture 322 and the second puncture 332 both reduce the spectral regrowth compared to not puncturing the data packet. The graph 300 also shows that the second puncture 332 (e.g., 40 MHz puncture) reduces the spectral regrowth more than the first puncture 322 (e.g., 20 MHz puncture). The first controller 112 and/or the second controller 122 may cause the first puncture 322 or the second puncture 332 to be generated to reduce spectral regrowth. Spectral regrowth may be reduced by 3 dB or more with a 40 MHz puncture and reduced by 6 dB or more with a 80 MHz puncture.

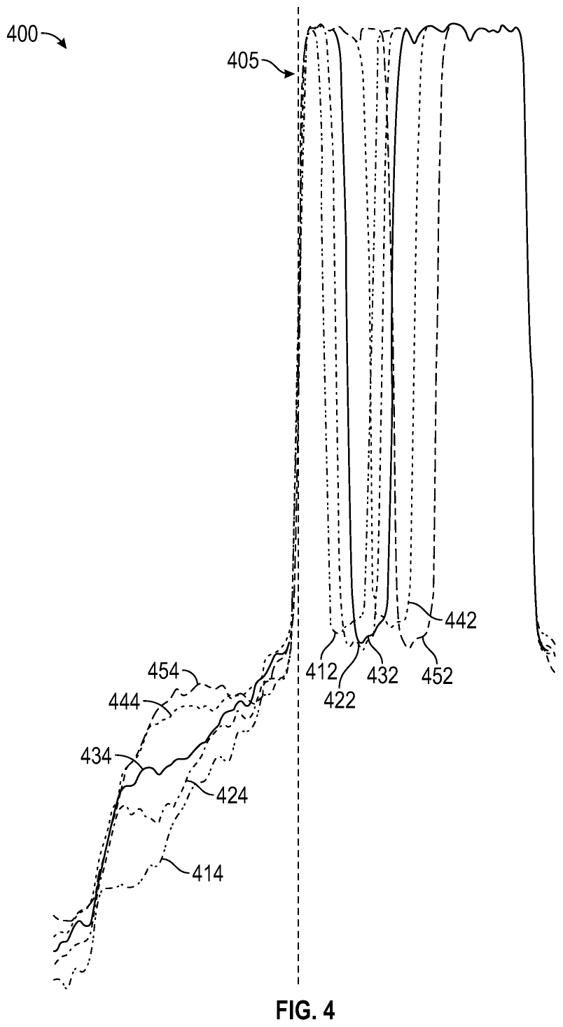

FIG. 4 is a graph 400 of example TX chain outputs with punctures in different positions. The graph 400 includes a first puncture 412, a second puncture 422, a third puncture 432, a fourth puncture 442, a fifth puncture 452, a left side spectral regrowth with first puncture 414, a left side spectral regrowth with second puncture 424, a left side spectral regrowth with third puncture 434, a left side spectral regrowth with fourth puncture 444, and a left side spectral regrowth with fifth puncture 454. The punctures may have the same resolution in graph 400, 80 MHz for example. Thus, the resolution of the punctures is not affecting the different levels of spectral regrowth reduction by the punctures.

The first puncture 412 may be 64 MHz from the left band edge 405. The second puncture 422 may be positioned 80 MHz from the left band edge 405. The third puncture 432 may be positioned 96 MHz from the left band edge 405. The fourth puncture 442 may be positioned 128 MHz from the left band edge 405. The fifth puncture 452 may be positioned 160 MHz from the left band edge 405.

Because of the different positions of the punctures compared to the left band edge 405, the punctures reduce the left side spectral regrowth to varying degrees. As shown by FIG. 4, the left side spectral regrowth with first puncture 414 is the lowest spectral regrowth, so the first puncture 412 has reduced the left side spectral regrowth the most. The punctures may reduce the spectral regrowth the closer the puncture is to the left band edge 405. Similarly, the punctures will reduce right side regrowth the closer the puncture is to the right band edge. Thus, the first puncture 412 reduces the left side spectral regrowth the most, the second puncture 422 is the next most effective, followed by the third puncture 432, the fourth puncture 442, and the fifth puncture 452, respectively.

The first controller 112 and/or the second controller 122 may cause the puncture to be positioned to improve the reduction of spectral regrowth at a side of the channel. For example, the first controller 112 and/or the second controller 122 may position the puncture closer to the side of the channel that the controller determines spectral regrowth should be reduced. For example, the controller may position the puncture 64 MHz from the left band edge (e.g., the left band edge 405) to improve the reduction of the spectral regrowth on the left side of the channel. Thus, as described above, spectral regrowth may be reduced by positioning and determining a resolution of puncture.

Spectral regrowth may also be reduced by adaptively assigning clients and reducing TX power for radios such as the first transceiver 114, the second transceiver 117, the third transceiver 124, and/or the fourth transceiver 127). The first controller 112 and/or the second controller 122 may adaptively assign clients (e.g., the first client 130, the second client 132) based on groupings of clients and/or based on link budgets of clients to support the Modulation and Coding Scheme (MCS). The first controller 112 and/or the second controller 122 may reduce TX power to one or more radios based on the assignment of clients. For example, the first controller 112 may group clients that are near the first MLD 110 (e.g., the first client 130) and clients that are far from the first MLD 110 (e.g., the second client 132). The first controller 112 may assign the group of clients near the first MLD 110 to the first transceiver 114 and the group of clients to the second transceiver 117. The first controller 112 may therefore determine the first transceiver 114 TX power may be reduced and still be able to communicate with the assigned group of clients. Thus, the first controller 112 may reduce the TX power of the first transceiver 114.

The first controller 112 and/or the second controller 122 may cause a radio to have a targeted power reduction. For example, the power reduction may be about a quarter of the BW away from one of the band edges. The first controller 112 and/or the second controller 122 may also cause the radio power reduction to be for a resolution (e.g., 20 MHz, 40 MHz, 80 MHZ).

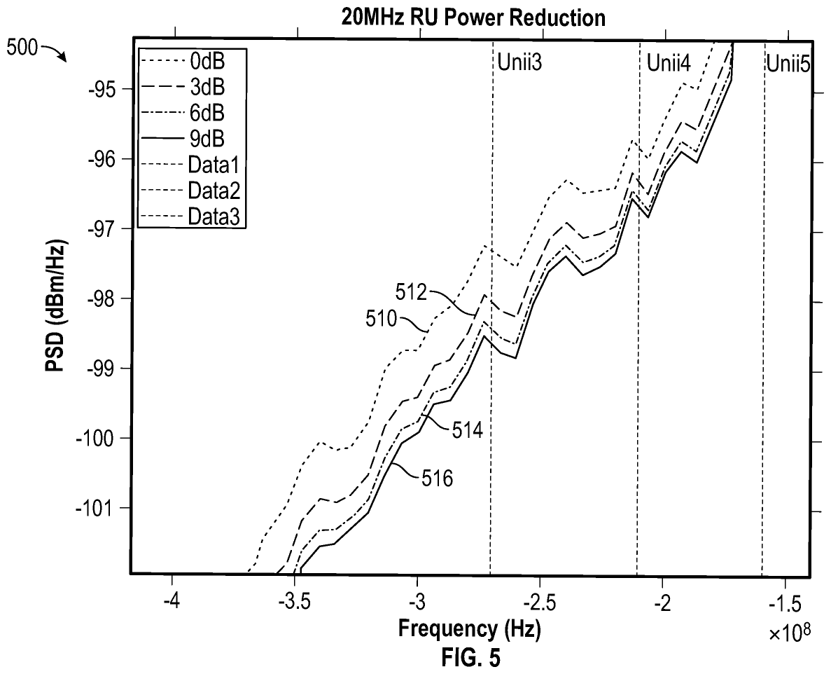

FIG. 5 is a graph 500 of example TX chain outputs with a power reduction for a 20 MHz resolution. The graph 500 includes a left side spectral regrowth with a 0 dB power reduction with 20 MHz resolution 510, a left side spectral regrowth with a 3 dB power reduction with 20 MHz resolution 512, a left side spectral regrowth with a 6 dB power reduction with 20 MHz resolution 514, and a left side spectral regrowth with a 9 dB power reduction with 20 MHz resolution 516.

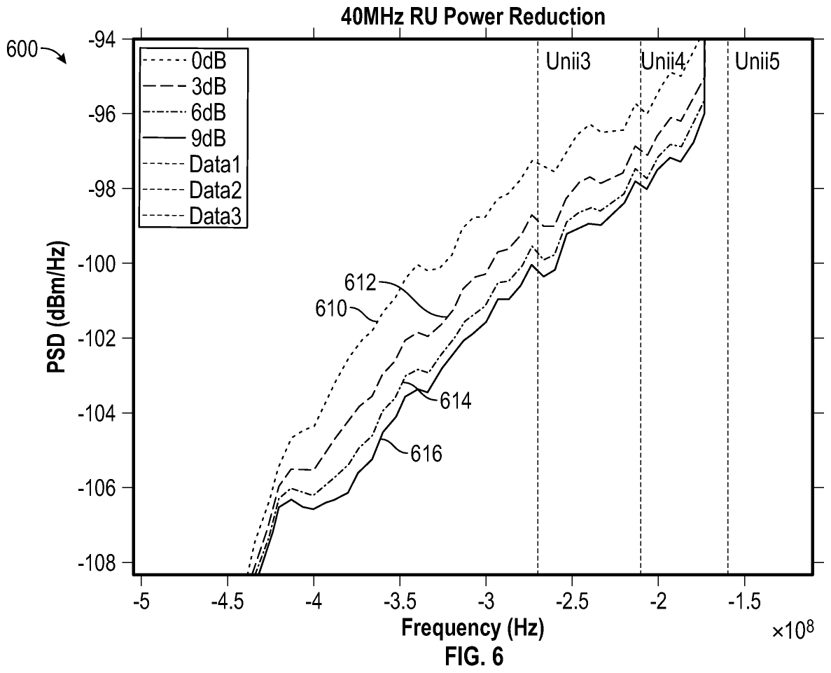

FIG. 6 is a graph of example TX chain outputs with a power reduction for a 40 MHz resolution. The graph 600 includes a left side spectral regrowth with a 0 dB power reduction with 40 MHz resolution 610, a left side spectral regrowth with a 3 dB power reduction with 40 MHz resolution 612, a left side spectral regrowth with a 6 dB power reduction with 40 MHz resolution 614, and a left side spectral regrowth with a 9 dB power reduction with 40 MHz resolution 616.

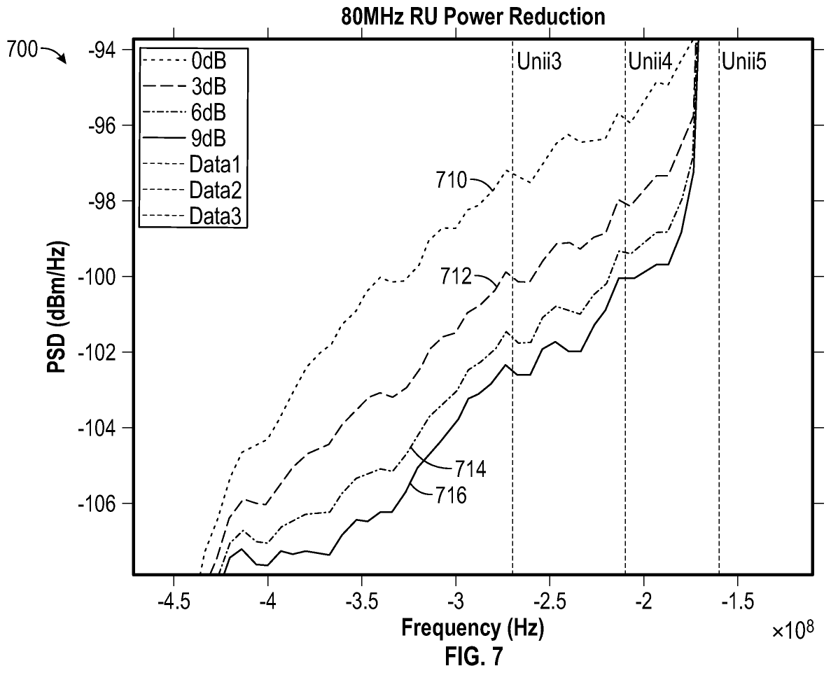

FIG. 7 is a graph of example TX chain outputs with a power reduction for an 80 MHz resolution. The graph 700 includes a left side spectral regrowth with a 0 dB power reduction with 80 MHz resolution 710, a left side spectral regrowth with a 3 dB power reduction with 80 MHz resolution 712, a left side spectral regrowth with a 6 dB power reduction with 80 MHz resolution 714, and a left side spectral regrowth with a 9 dB power reduction with 80 MHz resolution 716.

As shown in FIG. 5, FIG. 6, and FIG. 7, for the power reduction of the 20 MHz, 40 MHz, and 80 MHz resolutions, the spectral regrowth more as the TX power decreases. Thus, the spectral regrowth is lowest when the power is reduced by 9 dB (e.g., the left side spectral regrowth with a 0 dB power reduction with 20 MHz resolution 510, the left side spectral regrowth with a 0 dB power reduction with 40 MHz resolution 610, and the left side spectral regrowth with a 0 dB power reduction with 80 MHZ resolution 710). The next lowest reduction would be when the power is reduced by 6 dB, followed by the 3 dB power reduction. Thus, the spectral regrowth may be reduced by reducing the TX power of radios.

The first controller 112 and/or the second controller 122 may also reduce in-band and/or broad band RF energy to alleviate RX blocking on a victim radio. The in-band and/or broad band RF energy from an aggressor radio may cause SNR compression for the victim radio, causing RX-blocking. The RX blocking may lead to RX-sensitivity impacts and/or EVM degradation.

The first controller 112 and/or the second controller 122 may reduce the in-band and/or broad band RF energy by either removing targeted intermodulation products or reducing TX power of the aggressor radio, as described above for example. The first controller 112 and/or the second controller 122 may determine to either remove targeted intermodulation products or reduce TX power based on the amount of RF energy that needs to be reduced to alleviate the RX blocking. The reduction of RF energy may lead to a reduction in the Peak-to-Average Power Ratio (PAPR), alleviate LNA RX saturation, and/or SNR compression, leading to improved RX-sensitivity and/or EVM.

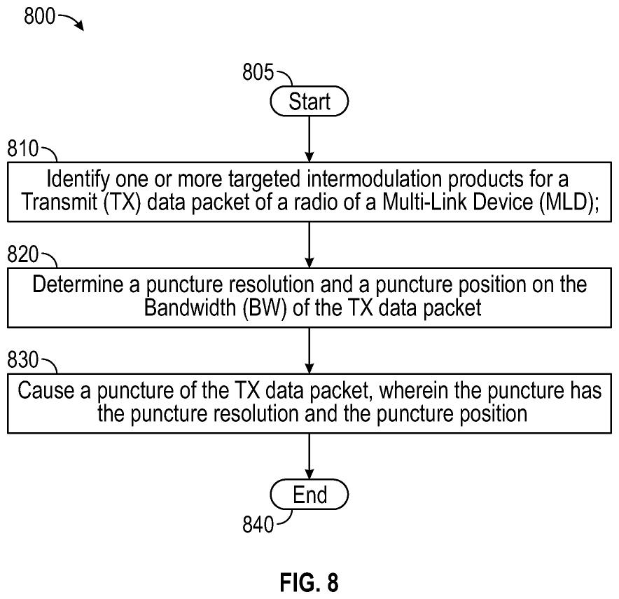

FIG. 8 is a flow chart of a method 800 for alleviating spectral regrowth and/or RX blocking by removing targeted intermodulation products. The method 800 may begin at starting block 805 and proceed to operation 810. In operation 810 one or more targeted intermodulation products for a TX data packet of a radio may be identified. The radio may be a radio of an MLD (e.g., the first MLD 110, the second MLD 120). For example, the first controller 112 may identify targeted intermodulation products for a TX data packet of the first transceiver 114. The first controller 112 may analyze TXs already sent by the first transceiver 114 and/or data packets that are to be sent by the first transceiver 114 to identify the targeted intermodulation products. The first controller 112 may identify the targeted intermodulation products according to the methods described above.

In operation 820, a puncture resolution and a puncture position may be determined. For example, the first controller 112 may determine the puncture resolution and the puncture position on the BW of the data packet. The first controller 112 may determine the puncture resolution and/or the puncture position based on the band edge to target to reduce spectral regrowth, the amount of spectral regrowth, the data loss that will occur due to the puncture position and/or puncture resolution, and/or the like. The first controller 112 may determine the puncture resolution and/or the puncture position according to the methods described above.

In operation 830, a puncture of the TX data packet may be caused. The puncture may have the puncture resolution and puncture position determined in operation 820. For example, the first controller 112 may cause the first puncture generator 113 to puncture the TX data packet with the determined puncture resolution at the puncture position. The method 800 may conclude at ending block 840.

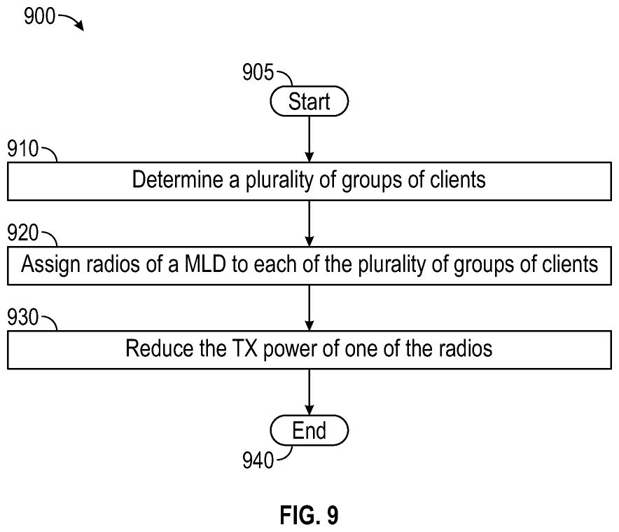

FIG. 9 is a flow chart of a method 900 for alleviating spectral regrowth and/or RX blocking by reducing TX power. The method 900 may begin at starting block 905 and proceed to operation 910. In operation 910, a plurality of groups of clients may be determined. For example, the first controller 112 may determine a plurality of groups of clients based on client position, client link budgets, and/or the like. Thus, the groups may include a group of clients that are closer to the first MLD 110 compared to other groups.

In operation 920, radios of an MLD may be assigned to the plurality of groups of clients. For example, the first controller 112 may assign the first transceiver 114 to the group of clients closer to the first MLD 110 and assign the second transceiver 117 to another group of clients.

In operation 930, the TX power of one of the radios may be reduced. For example, the first controller 112 may reduce the TX power of the first transceiver 114 because the first transceiver 114 may still communicate with the group of closer clients with the lower TX power. Method 900 may conclude at ending block 940.

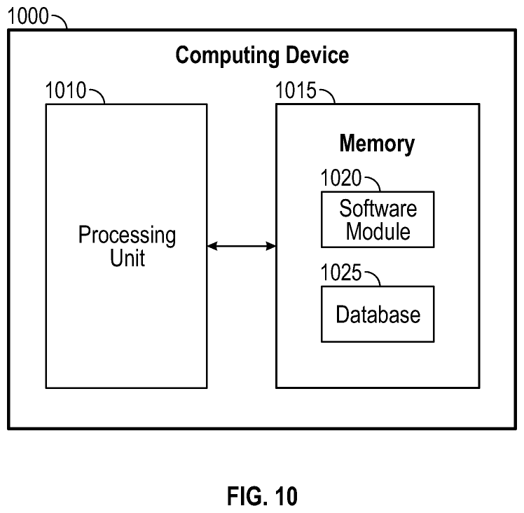

FIG. 10 is a block diagram of a computing device 1000. As shown in FIG. 10, computing device 1000 may include a processing unit 1010 and a memory unit 1015. Memory unit 1015 may include a software module 1020 and a database 1025. While executing on processing unit 1010, software module 1020 may perform, for example, processes for alleviating spectral regrowth and/or RX blocking with respect to FIG. 1, FIG. 2, FIG. 3, FIG. 4, FIG. 5, FIG. 6, FIG. 7, FIG. 8, and FIG. 9. Computing device 1000, for example, may provide an operating environment for the first MLD 110, the first controller 112, the first puncture generator 113, the first transceiver 114, the second transceiver 117, the second MLD 120, the second controller 122, the second puncture generator 123, the third transceiver 124, the fourth transceiver 127, the first client 130, the second client 132, and the like. The first MLD 110, the first controller 112, the first puncture generator 113, the first transceiver 114, the second transceiver 117, the second MLD 120, the second controller 122, the second puncture generator 123, the third transceiver 124, the fourth transceiver 127, the first client 130, the second client 132, and the like may operate in other environments and are not limited to computing device 1000.

Computing device 1000 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1000 may comprise any computer operating environment, such as hand-held devices, multiprocessor systems, microprocessor-based or programmable sender electronic devices, minicomputers, mainframe computers, and the like. Computing device 1000 may also be practiced in distributed computing environments where tasks are performed by remote processing devices. The aforementioned systems and devices are examples, and computing device 1000 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1000 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
identifying one or more targeted intermodulation products for a Transmit (TX) data packet of a radio of a Multi-Link Device (MLD);
determining a puncture resolution and a puncture position on a Bandwidth (BW) of the TX data packet; and
causing a puncture of the TX data packet, wherein the puncture has the puncture resolution and the puncture position.

2. The method of claim 1, wherein the puncture resolution is any one of 20 MHz, 40 MHz, or 80 MHz.

3. The method of claim 1, wherein the puncture resolution is any one of 64 MHz from a left band edge of the data packet, 80 MHz from the left band edge, 96 MHz from the left band edge, 128 MHz from the left band edge, or 160 MHz from the left band edge.

4. The method of claim 1, wherein the puncture resolution is any one of 64 MHz from a right band edge of the data packet, 80 MHz from the right band edge, 96 MHz from the right band edge, 128 MHz from the right band edge, or 160 MHz from the right band edge.

5. The method of claim 1, wherein determining the puncture resolution and the puncture position is based on any one of (i) a band edge to target to reduce spectral regrowth, (ii) an amount of spectral regrowth, (iii) a data loss that will occur due to the puncture position and the puncture resolution, or (iv) any combination of (i)-(iii).

6. The method of claim 1, further comprising normalizing a power of the data packet with the puncture.

7. The method of claim 1, wherein the puncture is TX mask.

8. A system comprising:
a memory storage; and
a processing unit coupled to the memory storage, wherein the processing unit is operative to:
identify one or more targeted intermodulation products for a Transmit (TX) data packet of a radio of a Multi-Link Device (MLD);
determine a puncture resolution and a puncture position on a Bandwidth (BW) of the TX data packet; and
cause a puncture of the TX data packet, wherein the puncture has the puncture resolution and the puncture position.

9. The system of claim 8, wherein the puncture resolution is any one of 20 MHz, 40 MHz, or 80 MHz.

10. The system of claim 8, wherein the puncture resolution is any one of 64 MHz from a left band edge of the data packet, 80 MHz from the left band edge, 96 MHz from the left band edge, 128 MHz from the left band edge, or 160 MHz from the left band edge.

11. The system of claim 8, wherein the puncture resolution is any one of 64 MHz from a right band edge of the data packet, 80 MHz from the right band edge, 96 MHz from the right band edge, 128 MHz from the right band edge, or 160 MHz from the right band edge.

12. The system of claim 8, wherein to determine the puncture resolution and the puncture position is based on any one of (i) a band edge to target to reduce spectral regrowth, (ii) an amount of spectral regrowth, (iii) a data loss that will occur due to the puncture position and the puncture resolution, or (iv) any combination of (i)-(iii).

13. The system of claim 8, the processing unit being further operative to:
normalize a power of the data packet with the puncture.

14. The system of claim 8, wherein the puncture is a TX mask.

15. A non-transitory computer-readable medium that stores a set of instructions which when executed perform a method executed by the set of instructions comprising:
identifying one or more targeted intermodulation products for a Transmit (TX) data packet of a radio of a Multi-Link Device (MLD);
determining a puncture resolution and a puncture position on a Bandwidth (BW) of the TX data packet; and
causing a puncture of the TX data packet, wherein the puncture has the puncture resolution and the puncture position.

16. The non-transitory computer-readable medium of claim 15, wherein the puncture resolution is any one of 20 MHZ, 40 MHZ, or 80 MHz.

17. The non-transitory computer-readable medium of claim 15, wherein the puncture resolution is any one of 64 MHz from a left band edge of the data packet, 80 MHz from the left band edge, 96 MHz from the left band edge, 128 MHz from the left band edge, or 160 MHz from the left band edge.

18. The non-transitory computer-readable medium of claim 15, wherein the puncture resolution is any one of 64 MHz from a right band edge of the data packet, 80 MHz from the right band edge, 96 MHz from the right band edge, 128 MHz from the right band edge, or 160 MHz from the right band edge.

19. The non-transitory computer-readable medium of claim 15, wherein determining the puncture resolution and the puncture position is based on any one of (i) a band edge to target to reduce spectral regrowth, (ii) an amount of spectral regrowth, (iii) a data loss that will occur due to the puncture position and the puncture resolution, or (iv) any combination of (i)-(iii).

20. The non-transitory computer-readable medium of claim 15, wherein the puncture is TX mask.
